(19) United States
(12) Patent Application Publication
(10) Pub. No.: US 2017/0206596 A1
(43) Pub. Date: Jul. 20, 2017

(54) Value at Risk Models for AML Compliance and Due Diligence

(71) Applicant: Tao Zhang, Haymarket, VA (US)

(72) Inventor: Tao Zhang, Haymarket, VA (US)

(73) Assignee: Tao Zhang, Haymarket, VA (US)

(21) Appl. No.: 15/001,148

(22) Filed: Jan. 19, 2016

(51) Int. Cl. G06Q 40/02; G06Q 10/06; G06Q 30/00; G06F 17/50

(52) U.S. Cl. CPC G06Q 40/02; G06F 17/5009; G06Q 10/06395; G06Q 30/018

(57) ABSTRACT

A method for applying a Value at Risk or VaR theory to AML compliance and due diligence is presented. The new method broadens the scope of the original VaR theory from measure of the risk loss on a given portfolio to measure of productiveness in AML compliance and due diligence. The method measures the productiveness of due diligence on suspicious activity in financial transactions by calculating the value of due diligence at risk. The new VaR theory for AML compliance and due diligence constructs three models to measure the value of due diligence at risk: a reference model to capture all key data elements and their combinations from historical transactions in an ideal process of maximum due diligence; a value at risk model for due diligence on new transactions; and a value at risk model for due diligence on historical transactions.

### FIELD OF THE INVENTION

The invention relates to constructing financial models of value at risk for collecting, analyzing, storing, processing, investigating key data elements and combinations of key data elements in financial transactions in connection with compliance with regulatory and/or statutory legal requirements.

### BACKGROUND OF INVENTION

Financial institutions such as banks are subject to regulatory requirements and scrutiny arising from rules, regulations or laws at the local, state, federal, or international level for compliance. In particular, banks are required to comply with the Bank Secrecy Act and its implementing regulations or AML (anti-money laundering) rules for detecting and reporting suspicious activity such as money laundering and terrorist financing.

Over the years, many financial institutions have developed sophisticated AML monitoring systems which rely increasingly on quantitative analysis and models for business decision making. There are risk and costs for quantitative decision making. To address the risk associated with decision making based on models, the U.S. Treasury's Office of the Comptroller of the Currency (OCC) and Federal Reserve issued comprehensive guidance for banks on effective model risk management in April, 2011.

In response to new guidance and requirements, banks in recent years have scrambled to construct and validate their models for AML programs. There is increasing need for effective and efficient methods, techniques, and processes for collecting, analyzing, investigating, and managing the transaction and reference data needed to promote compliance with federal laws and regulations, such as the USA Patriot Act.

In a typical AML due diligence process, banks perform due diligence on between 1% and 10% of the total transactions due to the limitation on resources available for due diligence or investigations. They rely heavily on scenarios and models to capture suspicious activity in their transactions in hope to perform significantly better than random selection within their limited coverage of risk transactions. Unfortunately, many currently implemented scenarios and models do not capture suspicious activity significantly better than random selection. In some cases, they even perform worse than random selection because they set thresholds for minimum transaction amount and count in their scenarios and models to cut alert volume significantly. The evidence collected over the years shows that lower values for transaction count and amount from aggregated transactions are more likely to be suspicious than higher values.

On the other hand, there are a significant amount of duplicated efforts done on the limited due diligence even within the small coverage of transactions. One reason is overlapping coverage among different scenarios and between consecutive look-back periods for the same scenario. Another reason is most scenarios and models do not take into account of prior due diligence performed on key data elements and their combinations in eliminating duplicated efforts of new due diligence with the same data elements and their combinations.

This invention describes a method to increase the coverage of due diligence on suspicious activity in transactions and/or to decrease the need for resources to perform due diligence by 1) capturing the most productive data elements and their combinations and by 2) minimizing duplicated efforts on key data elements and their combinations.

### SUMMARY OF THE INVENTION

This invention presents a method for a process of due diligence on suspicious transactions to achieve better effectiveness and efficiency by measuring productiveness of due diligence through value at risk, promoting most productive due diligence, and eliminating least productive due diligence.

The method constructs three VaR (Value at Risk) models for measuring the productiveness of due diligence: a reference model to capture maximum due diligence achieved in an ideal world, a model for due diligence on new transactions, and a model for due diligence on historical transactions.

The VaR reference model constructs a dictionary of key data elements and their combinations in historical transactions. It provides a baseline or reference for comparison to measure the productiveness of due diligence on data elements in new and historical transactions.

The VaR model for due diligence on new transactions measures the productiveness or effectiveness of due diligence. This is done by comparing key data elements and their combinations in new transactions with those in historical transactions captured in the reference model. It identifies new transactions that are more productive for due diligence.

The VaR model for due diligence on historical transactions measures the productiveness of due diligence on historical transactions. This is done by comparing key data elements and their combinations in historical transactions captured in the reference model with those in an existing due diligence process. It identifies historical transactions that are more productive for due diligence.

### BRIEF DESCRIPTION OF THE FIGURES

The utility of the embodiments of the invention can be readily appreciated and understood from consideration of the following description of those embodiments of the invention viewed in connection with the accompanying drawings, wherein:

FIG. 1 represents the overall method of the invention of VaR for AML Compliance and Due diligence: VaR Reference Model for Maximum Due Diligence, VaR Model for Due Diligence of New Transactions, and VaR Model for Due Diligence of Historical Transactions;

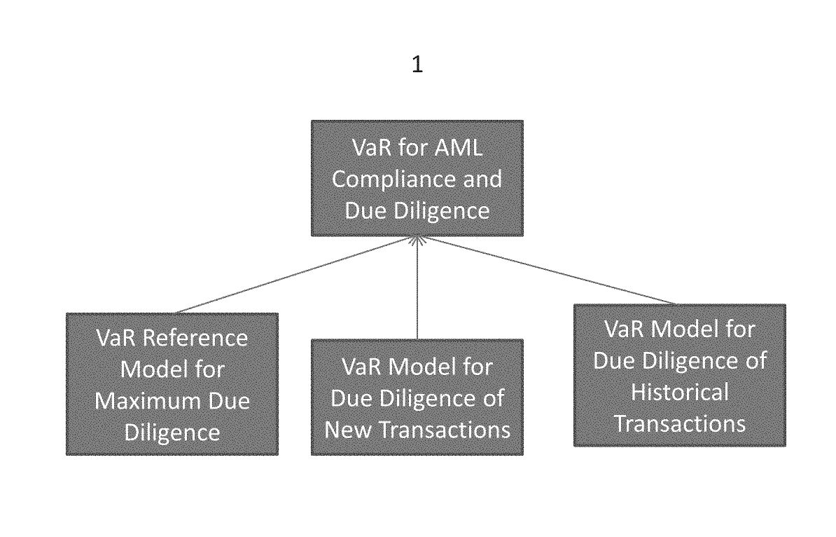

FIG. 2 represents VaR Reference Model for Maximum Due Diligence: Data Elements and Combinations of Data Elements;

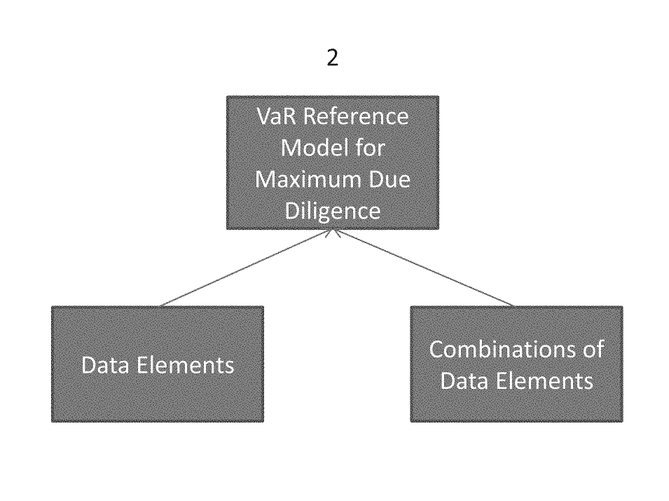

FIG. 3 represents VaR Model for Due Diligence of New Transactions: Maximum VaR Segment—No Key Data Element Captured in Reference Model (1-to-1, 1-to-many, many-to-1, many-to-many groups), High VaR Segment—Key Data Elements Partially Captured in Reference Model (1-to-1, 1-to-many, many-to-1, many-to-many groups), Low VaR Segment—All Key Data Elements Captured in Reference Model (1-to-1, 1-to-many, many-to-1, many-to-many groups), Minimum VaR Segment—All Key Data Elements and Their Combinations Captured in Reference Model (1-to-1, 1-to-many, many-to-1, many-to-many groups);

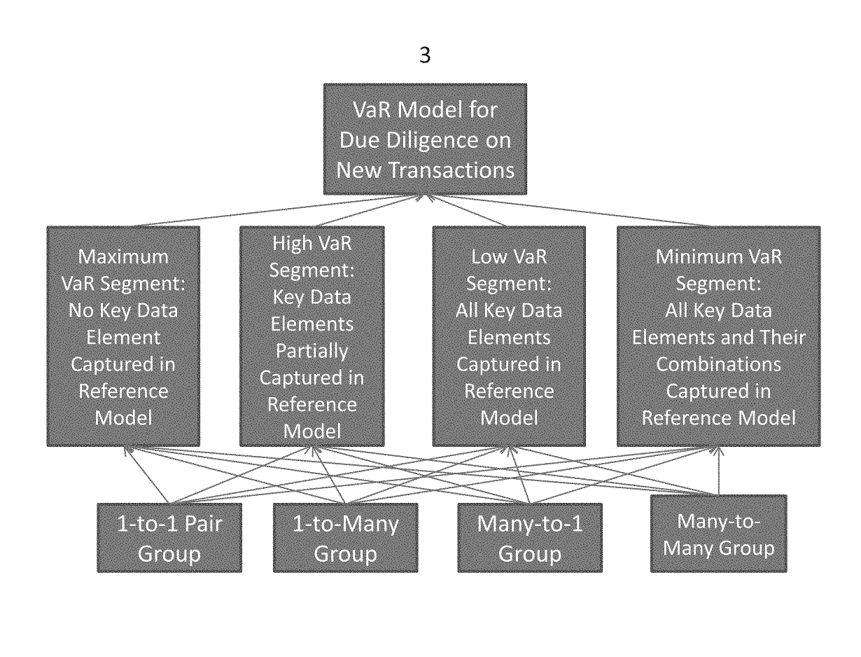

FIG. 4 represents VaR Model for Due Diligence of Historical Transactions: Productive Data Elements from Gap Analysis of Comparison of Due Diligence of Historical Transactions in Reference Model with Due Diligence of Historical Transactions in Existing Due Diligence Process;

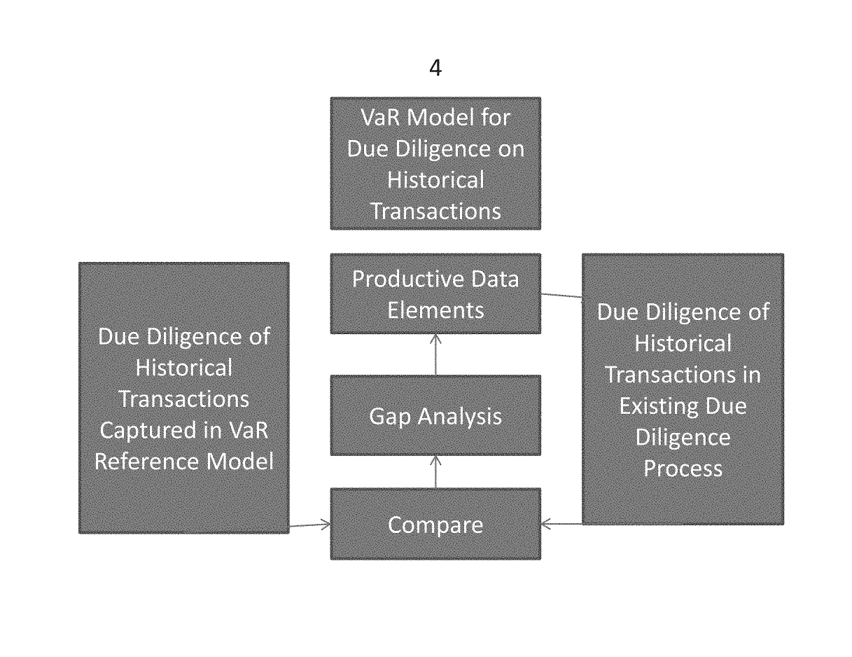

### DETAILED DESCRIPTION OF THE INVENTION

This invention presents a method to achieve effective and efficient due diligence in AML compliance. The new method constructs three models to measure the effectiveness and efficiency of due diligence in AML compliance: a reference model to capture an ideal world of maximum due diligence, a model for due diligence on new transactions, and a model for due diligence on historical transactions.

This invention presents a VaR theory and applies it to measuring and optimizing the effectiveness (risk coverage) and efficiency (cost) of due diligence in terms of productiveness of due diligence on suspicious transactions. It is productive if something is learned from a due diligence process that was not learned before. It is non-productive if nothing new is leaned from the due diligence process.

The productiveness of due diligence is measured by value of due diligence at risk or value of cost of due diligence at risk. The minimum value is zero if nothing learned from new due diligence that is not captured in historical due diligence. The maximum value is the cost of due diligence if nothing from new due diligence is captured in historical due diligence.

The productiveness of the due diligence of new transactions and historical transactions are measured separately due to different characteristics associated with suspicious activity. Non-repeatable or less-repeatable suspicious activities are better captured in due diligence on new transactions. Repeatable suspicious activities are better measured from historical transactions. In comparison, most scenarios and models currently in use at various banks are designed to capture suspicious activities from new transactions.

A reference model from the new VaR theory constructs a dictionary of key data elements and their combinations/aggregates from historical transactions in each of due diligence periods in a look-back period. A due diligence period is defined as a time period for which due diligence has been performed. A typical due diligence period is one month. Other periods are a day, week, quarter, or multiples of a day, week, or month. Due diligence in the form of investigation of suspicious transactions is carried out in a given due diligence period. The process is repeated for each of the due diligence periods in a look-back period of time. The look-back period for due diligence is a multiple of a due diligence period. A typical look-back period for a due diligence is 6, 12, or 18 months.

In a given due diligence period, extraction of data elements, their combinations and their aggregates for reference is carried out from historical transactions in the same due diligence period. Data elements in transactions of different types may be extracted separately. In wires, key data elements include originating parties and beneficiary parties. They are extracted by party name, party ID, or both. The extracted parties may be identified by party type: internal account, external entity, or customer type. In MI or monetary instrument transactions, key data elements include remitting parties and beneficiary parties extracted by party name and/or party ID, internal account, external entity, or customer. In cash transactions, key data elements include internal accounts or customers.

Similarly, extraction of combinations of key data elements are carried out from historical transactions in the same due diligence period as extraction of data elements. Combinations of key data elements for due diligence on entities are pairs of originating parties and beneficiary parties in wires, and pairs of remitting parties and beneficiary parties in MI transactions. Combinations of data elements for due diligence on countries include the originating party, the originating country, and the sending bank's country, or beneficiary party, the beneficiary's country, and the receiving bank's country in wires. In MI, they include remitting party, the remitting country, and the issuing bank's country, or beneficiary party, the beneficiary's country, and the depositing bank's country. In cash transactions, examples of combinations of data elements are internal accounts and location countries.

A dictionary is built to store the extracted data elements and combinations of data elements from historical transactions for each of due diligence periods in a look-back period for due diligence. The dictionary provides information on what is captured in an ideal or virtual world of maximum due diligence or what could have been done on due diligence of all historical transactions. This information is used as baseline or reference by VaR model for due diligence on both new transactions to identify productive due diligence on new transactions and on historical transactions to identify productive due diligence on historical transactions.

A VaR model for due diligence in new transactions measures the productiveness of due diligence of data elements and their combinations/aggregates in new transactions by comparing them with those captured in the VaR reference model. Due diligence of a new transaction is productive if key data elements in the transaction are not captured in the reference model. It generates an alert from new transactions if it is significantly productive measured by VaR.

The productiveness of due diligence on a new transaction is measured by value at risk or VaR. VaR is minimum or zero if no new information is extracted from key data elements and their combinations in a new transaction in comparison to what are already captured in the reference model from historical transactions.

On the other hand, the value of productiveness at risk from due diligence on a new transaction is maximum or equal to the cost of due diligence if no key data element in the new transaction is captured in the reference model.

In general, the value of due diligence at risk on a new transaction is between zero and the due diligence cost if some data elements in the new transaction are captured and others are not captured in the reference model.

For example, VaR for a wire between party ABC and counter party XYZ in a new transaction is a minimum or zero if historical wires between the same two parties are captured in each due diligence period in the VaR reference model. If both ABC and XYZ are not captured in the reference model from historical transactions, VaR would be a maximum or equal to the cost of investigation of the wire. If either ABC or XYZ, but not both, is captured in the reference model, VaR would be between 0 and the cost of investigation of the wire.

The VaR model for due diligence on new transactions may generate alerts from new transactions from 4 scenarios for different grouping: 1-to1 or 1to1, 1-to-many or 1toM, many-to-1 or Mto1, and many-to-many or MtoM.

Scenario 1 to1 identifies exclusive 1-to-1 pairs: a pair of primary party and counter party in one or more transactions between the pair without transactions with any other party in the same due diligence period.

Scenario 1 toM captures 1-to-many groups: a group of multiple parties with one party originating wires/remitting MI transactions to multiple beneficiary parties. All parties in the same 1-to-many group had no transactions with any party outside the group in the same due diligence period.

Scenario Mto1 is designed to catch many-to-1 groups: a group of multiple parties with one beneficiary party receiving transactions from multiple parties. All parties in the same many-to-1 group had no transactions with any party outside the group in the same due diligence period.

Scenario MtoM is to find many-to-many groups: a group of multiple parties sending transactions to multiple parties in the same group. All parties in the same many-to-many group had no transactions with any party outside the group in the same due diligence period.

The VaR model for due diligence on new transactions assigns value at risk or VaR for entity to each party, and assigns VaR for entity to each group by taking a value from a function of VaRs for entity from all parties in the group. For example, it may take an average of VaRs for entity from all parties in each group.

The VaR model for due diligence on new transactions assigns value at risk or VaR for relationship to each pair of parties, and assigns VaR for relationship to each group by taking a value from a function of VaRs for relationship from all pairs of parties in the group appearing in new transactions. For example, it may take an average of VaRs for relationship from all parties in each group.

The VaR model for due diligence on new transactions divides all groups into 4 segments by VaR: maximum VaR groups, high VaR groups, low VaR groups, and minimum VaR groups.

A group in maximum VaR segment is a group of parties when no party in the group is captured in the VaR reference model.

A group in low VaR segment is a group of parties when every party in the group is captured in the VaR reference model.

A group in high VaR segment is a group of parties when some, not all, of parties in the group are captured in the VaR reference model.

A group in minimum VaR segment is a group of parties whose relationships appeared in new transactions are all captured in the VaR reference model from historical transactions.

For example, assume a 1 toM group of 3 parties: A, B, and C. A sent 3 wires to B, and sent 4 wires to C. The group should be in maximum VaR segment if none of A, B, and C is captured in the VaR reference mode. It should be in low VaR segment if all 3 parties are captured in the reference model. If one or two of the three parties are captured in the reference model, the group should be in high VaR segment. It should be in minimum VaR segment if pair (A, B) and pair (A, C) are captured in the combinations of key data elements in the reference model.

Alerts are generated from 4 scenarios described above by group in each VaR segment. The overall strategy for generating alerts from 4 VaR segments is as follows. It generates a high volume of alerts in percentage from maximum VaR segment because transactions in this segment have no key data elements captured in the VaR reference model and are most productive for due diligence. It generates a less than high volume of alerts in percentage from high VaR segment due to partial capture of some key data elements in the reference model. It generates a low volume of alerts in percentage from low VaR segment since all key data elements in new transactions are captured in the reference model. It generates a minimum volume of alerts in percentage from minimum VaR segment as not only all key data elements are captured in the reference model, but also combinations of key data elements in new transactions are captured in the reference model.

There are a number of approaches to generate alerts in each VaR segment. One approach is to use secondary scenarios to measure or calculate VaR for each group to differentiate various groups within the same segment by VaR. Generate alerts from the groups with higher VaRs from secondary scenarios.

One of secondary scenarios is VaR structuring scenario to capture high structuring risk for due diligence. The scenario is designed to capture structuring risk measured by structuring value at risk. A structuring VaR or VaR for structuring risk is defined by the difference between maximum transaction amount and minimum transaction amount divided by the maximum amount from all transactions between a pair of parties in a given due diligence period. For example, assume 10 transactions between ABC and XYZ with transaction amounts between $990 and $1,000. Structuring value at risk is 1% or 0.01=(1000−990)/1000. A smaller VaR represents a higher structuring risk. For example, VaR for structuring risk from 10 transactions between A and X with amount between $500 and $1,000 is 50% which has much smaller structuring risk than that for ABC and XYZ.

Another secondary scenario is VaR geo-risk scenario to capture high geo risk for due diligence. It is designed to capture geo risk measured by geo value at risk. A geo VaR is defined by the difference between country of originator and country of sending bank or between country of beneficiary and country of receiving bank in a transaction for the purpose of due diligence. For example, assume ABC sent wires with address country differing from the country for sanding bank. Geo VaR for the wires would be a maximum if the pair of the two countries is not captured in the reference model. Geo VaR would be a minimum if the pair is captured in the reference model whenever ABC sent wires in the look-back period of due diligence.

A VaR model for due diligence on historical transactions captures past due diligence and investigations carried out in an existing due diligence process. It compares the existing due diligence process with the maximum due diligence captured in the VaR reference model to identify the gap between an existing due diligence process and the maximum due diligence captured in the reference model. The VaR model for due diligence on historical model analyzes the gap and identifies productive data elements captured in the reference model for new due diligence in the existing process.

For example, the VaR model for due diligence on historical transactions may capture pairs of entities and/or groups of parties from historical transactions that had minimum due diligence done in the existing due diligence process, and may capture transactions across multiple due diligence periods sharing the same key data elements and their combinations that had minimum due diligence done in the existing due diligence process.

One common issue encountered in an AML detection or due diligence process is missing alerts from some transactions and duplicated alerts from other transactions due to aggregating transactions in a process using static look-back periods.

In a typical AML detection process using a static look-back period of 14 days, transactions are aggregated in a given 14 days. An alert is generated if the aggregated transaction amount in a given look-back period is no less than a threshold for minimum amount of $10,000 for example. Most current AML detection processes run look-back aggregates using one of two methods: non-overlapping look-back and overlapping look-back.

In a non-overlapping look-back process of 14 days, it aggregates transactions in each of consecutive 14 days for the same entity. In a period of 28 days, it generates an alert in first 14 days if the aggregated transaction amount is no less than $10,000. It generates another alert from aggregated transactions between day 15 and day 28 if the aggregate amount is no less than $10,000. It would not generate any alert if the aggregated amount is $7,500 in the first 14 days and the aggregated amount of transactions between day 15 and day 28 is also $7,500. This process would miss an alert generated from aggregated amount of $15,000 in 14 days between day 8 and day 21 if the aggregated amount is $7,500 between day 8 and day 14 and the aggregated amount is $7,500 between day 15 and day 21. The consequence for running non-overlapping look-back periods in sequence is missing potential alerts that should be generated in a run frequency smaller than a look-back period.

In a static look-back process of 14 days with 7 days of overlapping, it aggregates transactions in 14 days and runs it every 7 days. It generates an alert from an aggregated amount of $10,000 or higher in first 14 days. It generates another alert between day 8 and day 21 if the aggregated amount is no less than $10,000. The second alert would be largely duplicated of the first alert if the aggregated amount between day 8 and day 14 is more than $10,000 and the aggregated amount between day 15 and day 21 is $1. The consequence for running overlapping look-back periods is generating largely duplicated alerts that should not be generated if the alerted transactions are excluded from a new aggregate.

Another common issue in an AML detection or due diligence process is to select a proper look-back period, one day, one week, two weeks, three weeks, or one month. An inappropriately chosen look-back period may lead to a significant number of missing alerts not captured from a given scenario. For example, one may aggregate transactions in a look-back period of 14 days and generate an alert if the aggregated amount is $10,000 or higher. Run the alert generation process every 7 days 3 times in 28 days. The first run aggregates transactions from first 14 days. The second run aggregates transactions from day 8 to day 21 with 7 days of overlapping with the first run between day 8 and day 14. The third run aggregates transactions between day 15 and day 28. Assume a zero aggregated amount in the first week, $4,000 in the second week, $4,000 in the third week, and $4,000 in the fourth week. No alert is generated from aggregated transactions from day 1 to day 14. No alert is generated from an aggregated amount between day 8 and day 21. No alert is generated from aggregated transactions from day 15 to day 28. This is because no aggregate amount is equal to or higher than $10,000 in any 14 consecutive days. On the other hand, one alert should be generated from aggregated transactions between day 8 and day 28 in a look-back period of 21 days. This alert would be missed if a look-back period is chosen to be 14.

This invention presents a method of aggregating transactions in a dynamic look-back period to address both issues: missing alerts due to the selection of an inadequate look-back period duplicated alerts from the overlapping look-back aggregates. A dynamic look-back period starts from the first transaction that has never been alerted before (non-alerted transaction) from a given scenario. The first new non-alerted transaction determines the start date for a look-back aggregate for each entity (customer, account, or external entity). It may be different for different entities as their first new non-alerted transactions may appear on different dates. In a new dynamic look-back period, transactions that have been alerted before from the same scenario are excluded from the new look-back aggregates. An alert is generated from transactions in a dynamic look-back period excluding transactions alerted before.

In a dynamic look-back period of 28 days with 7 days of overlapping, it aggregates transactions in 28 days or less starting from the first non-alerted transaction. It would not miss any alert like those missed in a non-overlapping look-back process and would not duplicate any alert like those duplicated in a static overlapping look-back process. In addition, it would generate one alert from the aggregated amount of $12,000 in 4 weeks in the above example that would be missed by an aggregate in 14 days of a static look-back period.

In conclusion, this invention presents a method for a due diligence process which includes a process of detection of suspicious transactions based on 3 VaR models to identify transactions of higher values for performing due diligence. In addition, a method to avoid generating duplicated alerts and preventing missing alerts due to aggregating transactions in static look-back periods in a detection and due diligence process was presented.

### REFERENCES

U.S. Patent Documents

| | | |
|---|---|---|
| 5966709 | Nov. 1998 | Zhang et al. |
| 5983232 | Nov. 1999 | Zhang |
| 6018734 | Jan. 2000 | Zhang et al. |
| 7369999 | May 2008 | DuBois et al. |
| 7620596 | Nov. 2009 | Knudson et al. |
| 7716165 | May 2010 | Zhang etal. |
| 7801811 | Sep. 2010 | Merrellet et al. |
| 7822660 | Oct. 2010 | Donoho etal. |
| 7930228 | Apr. 2011 | Hawkins et al |
| 8055528 | Nov. 2011 | Sass etal. |
| 8442953 | May 2013 | Lawrence et al. |
| 8498931 | Jul. 2013 | Ahrahamset et al. |
| 8543444 | Sep. 2013 | Agle et al. |
| 8544727 | Oct. 2013 | Quinn et al. |
| 9058380 | Jun. 2015 | Lesiecki et al. |
| 9058581 | Jun. 2015 | Lawrence etal. |

### Other References

Federal Financial Institutions Examination Counsel, “Bank Secrecy Act Anti-Money Laundering Examination Manual”,

http://web.archive.org/web/20061007131729/http://www.ffiec.gov/bsa.sub.—aml.sub.—infobase/pages.sub.—manual/OLM.sub.—028.htm, Oct. 7, 2006, retrived Nov. 5, 2009. cited by examiner.

Financial Crimes Enformcement Network, “Interagency Interpretive Guidance on Providing Banking Services to Money Services Businesses Operating in the United States”,

http://web.archive.org/web/20050428145522/http://www.fdic.gov/news/news/financial/2005/fil3205a.html, retrived Nov. 6, 2009. cited by examiner.

“Mantas Anti-Money Laundering,” printed from

http://www.mantas.com/Products/RegulatoryCompliance/AntiMoneyLaundering.html Internet site, accessed on May 31, 2007, 3 pages. cited by other.

“Mantas Supports Section 312 of US Patriot Act,” printed from

http://www.mantas.com/Products/RegulatoryCompliance/USAPA312.html Internet site, accessed on May 31, 2007, 2 pages. cited by other.

“Bankers Systems, Inc. develops new product packages to help financial institutions comply with USA Patriot Act,” Bankers Systems Inc.®, Press Release dated Mar. 4, 2002, printed from http://www.bankerssystems.com/newsroom/Press.sub.—Releases/press23.html, Internet site, accessed on Aug. 15, 2006, 3 pages. cited by other Banks Comply with USA Patriot Act,” Bankers Systems Inc.®, Press Release dated Sep. 22, 7001, printed from

http://www.bankerssystems.com/newsroom/Press.sub.—Releases/press55.html, Internet site, accesses on Aug. 15, 2006, 2 pages. cited by other.

ACTIMIZE—Brokerage Compliance, Anti-Money Laundering, Financial Fraud Prevention, “Solutions—AML/USPA Compliance,” printed from

http://www.actimize.com/asp/sub/asp?sec=116&sub=947, Internet site, accessed on Jan. 27, 2005, 4 pages. cited by other.

What is claimed is:

1. A method for a process of due diligence on suspicious transactions using value at risk or VaR models comprising: constructing a reference model to capture all key data elements, their combinations, and their aggregates from historical transactions in an ideal world of maximum due diligence; constructing a VaR model for due diligence on new transactions; and constructing a VaR model for due diligence on historical transactions.

2. The method of claim 1, wherein the VaR reference model includes constructing a dictionary from extraction of all key data elements, combinations of key data elements, and their aggregates from historical transactions.

3. The method of claim 2, wherein the extraction of all key data elements, their combinations and aggregates from historical transactions includes the extraction for each due diligence period in a look-back period of due diligence.

4. The method of claim 2, wherein the extraction of key data elements in transactions such as wires, monetary instrument or MI, and cash transactions includes extracting an originating entity in a wire transaction—customer, account, external entity played an originating role in a wire transaction; extracting beneficiary entity in a wire—customer, account, external entity played a beneficiary role in a wire transaction; extracting remitting entity in an MI transaction—customer, account, external entity played a remitting role in an MI transaction; extracting beneficiary entity in an MI transaction—customer, account, external entity played a beneficiary role in an MI transaction; extracting debiting entity in a cash transaction—customer, account with cash withdrawal; and extracting crediting entity in a cash transaction—customer, account with cash deposit.

5. The method of claim 2, wherein the extraction of combinations of key data elements in historical transactions includes extracting pairs of primary party (originator/beneficiary) and counter party (beneficiary/originator) in a wire transaction—customer and customer, account and account, external entity and external entity, customer and external entity, account and external entity in a wire transaction; and extracting pairs of primary party (remitter/beneficiary) and counter party (beneficiary/remitter) in an MI transaction—customer and customer, account and account, external entity and external entity, customer and external entity, account and external entity in an MI transaction.

6. The method of claim 1, wherein the VaR model for due diligence on new transactions includes grouping new transactions in a due diligence period by 4 types of groups of entities or parties in transactions: exclusive 1-to-1 pair groups; 1-to-many groups; many-to-1 groups; and many-to-many groups.

7. The method of claim 1, wherein the VaR model for due diligence on new transactions includes assigning a value at risk or VaR to a key data element and to a combination of key data elements in a new transaction; assigning a VaR to a group of data elements; and generating alerts from groups having higher VaRs.

8. The method of claim 7, wherein the VaR model for due diligence on new transactions includes assigning a VaR for entity to each party in a group; and assigning a VaR for entity to each group by taking a value from a function of VaRs for entity from all parties in the group.

9. The method of claim 7, wherein the VaR model for due diligence on new transactions includes assigning a VaR for relationship to each combination of data elements or each pair of parties in new transactions; and assigning a VaR for relationship to each group by taking a value from a function of VaRs for relationship from all pairs of parties in the group appearing in new transactions.

10. The method of claim 7, wherein the VaR model for due diligence on new transactions includes dividing groups into 4 segments by VaR: maximum VaR segment; high VaR segment; low VaR segment; and minimum VaR segment.

11. The method of claim 10, wherein the VaR model for due diligence on new transactions includes assigning a group of parties with no party being captured in the VaR reference model into maximum VaR segment; assigning a group of parties with each party being captured in the VaR reference model into low VaR segment; assigning a group of parties with some parties being captured in the VaR reference model into high VaR segment; and assigning a group of parties with each pair of parties in transactions being captured in the VaR reference model into minimum VaR segment.

12. The method of claim 7, wherein the VaR model for due diligence on new transactions includes generating the highest percentage of alerts from maximum VaR segment; generating second highest percentage of alerts from high VaR segment; generating second lowest percentage of alerts from low VaR segment; and generating a minimum number of alerts from minimum VaR segment.

13. The method of claim 12, wherein the VaR model for due diligence on new transactions includes identifying groups with higher VaRs in each segment by secondary scenarios.

14. The method of claim 13, wherein the secondary scenarios include VaR structuring scenario to capture high structuring risk measured by structuring VaR defined by the difference between maximum transaction amount and minimum transaction amount divided by the maximum amount from all transactions between a pair of parties in a given due diligence period.

15. The method of claim 13, wherein the secondary scenarios include VaR geo-risk scenario to capture high geo risk measured by geo VaR defined by the difference between country of originator and country of sending bank or between country of beneficiary and country of receiving bank in a transaction.

16. The method of claim 1, wherein the VaR model for due diligence on historical transactions includes capturing past due diligence carried out in an existing due diligence process; comparing the existing due diligence process with the maximum due diligence captured in the VaR reference model; identifying productive data elements and their combinations captured in the reference model, but not in the existing due diligence process; and promoting historical transactions containing productive data elements for due diligence.

17. The method of claim 19, wherein the VaR model for due diligence on historical transactions includes identifying pairs of entities or parties from historical transactions that had minimum due diligence done in the existing investigation process; identifying groups of parties/entities linked by historical transactions that had minimum due diligence done in the existing due diligence process; and identifying transactions across multiple due diligence periods sharing the same key data elements and their combinations that had minimum due diligence done in the existing due diligence process.

18. A method for aggregating suspicious transactions in a dynamic look-back period in AML detection or due diligence process comprising: constructing a dynamic look-back period; aggregating suspicious transactions in the dynamic look-back period; and generating an alert if the aggregated transactions satisfying the alert generation criteria in a dynamic look-back period.

19. The method of claim 18, wherein aggregating suspicious transactions in a dynamic look-back period includes starting a look-back from the first new transaction that has never been alerted before for a given entity (customer, account, external entity) from a given scenario; excluding any transaction previously alerted from the same scenario; aggregating the new transactions in the dynamic look-back period; and generating an alert if the aggregated transactions satisfying the threshold criteria for alert generation.
